(19) United States
(12) Patent Application Publication
(10) Pub. No.: US 2011/0230197 A1
(43) Pub. Date: Sep. 22, 2011

(54) System and apparatus for high speed train communication

(76) Inventors: Shiquan Wu, Ottawa (CA); Baohong Sun, Ottawa (CA)

(21) Appl. No.: 13/064,166

(22) Filed: Mar. 9, 2011

Related U.S. Application Data
(60) Provisional application No. 61/282,720, filed on Mar. 22, 2010.

(51) Int. Cl. H04W 72/04

(52) U.S. Cl. 455/450

(57) ABSTRACT

This invention discloses a wireless communication system and apparatus for ground to high speed train communication. Unlike other priori arts, the proposed system exploits the train time table, train operating scenarios and GSM-R timing provision so that the train-presence triggered broadband wireless communication can be realized with better performance and less cost. There are provided system architectures and functionality of each apparatus and implementation details.

### CLAIM OF PRIORITY

This patent application claims the benefit of priority from U.S. Provisional patent application No. 61/282,720 filed on Mar. 22, 2010. This application incorporates by reference the entire disclosure of U.S. Provisional patent application No. 61/282,720.

### 1. FIELD OF THE INVENTION

This invention relates to wireless communication for high speed train and train presence triggered wireless communication.

### 2. BACKGROUND OF THE INVENTION

In some countries such as Japan, Europe, China and USA, high speed trains are becoming popular, which provide conveniences for passengers. The train speed kept accelerating in the past 10 years. The recent commercial trial in China demonstrated a peak speed of 394.2 km per hour with an average speed over 350 km per hour. The acceleration is still continuing. At such velocity, the drivers even cannot view what's happening beside the railway, not to mention high speed internet access for the passengers inside the cabin. Today, most of the wireless standards, if not all, have been designed and developed to support a vehicle speed up to 250 km per hour.

There are different train control systems in practice, for example ETCS2 and CTCS2. ETCS 2 is a digital radio and train protection system as illustrated FIG. 1. The train regularly reports its exact position and travel direction to the radio block centre (RBC). The RBC monitors the train movements, transmit the movement authority, speed information and route data continuously to the train through GSM-R.

GSM-R is the abbreviation for Global System for Mobile Communications-Railway. GSM-R is an international wireless communication standard for railway automation, management and applications.

GSM-R is built on top of GSM technology and the standard is the result of over ten years collaboration among the many European railway companies, with the goal of achieving interoperability using a single communication platform. GSM-R is part of the new European Rail Traffic Management System (ERTMS) standard and carries the signaling information directly to the train driver, enabling higher train speeds and traffic density with a high level of safety.

GSM-R standards were finalized in 2000 and the specification is being maintained by the International Union of Railways project ERTMS. GSM-R has been selected by more than 38 countries in the world.

GSM-R is an enhancement of GSM for voice and data communication between railway operational staff, including drivers, dispatchers, shunting team members, train engineers, and station controllers. Comparing to GSM, it adds new features such as voice group call service (VGCS), voice broadcast service (VBS), location-based connections, and call pre-emption in case of an emergency.

GSM-R is typically deployed with dedicated base stations close to the railway. The distance between adjacent base stations can be 7-15 km. The train is always connected with the train control centre via a digital modem which operates with higher priority than normal users. If the modem connection is lost, the train will automatically stop.

GSM-R system has a well defined GSM-R frame structure to enable the orderly information passage. The GSM-R frame structure establishes schedules for the predetermined use of timeslots.

By establishing these schedules through the use of a frame structure, on-board train GSM-R terminal and ground GSM-R base station can communicate voice, data and signaling information with various types of data. GSM-R terminal and GSM-R base station knows exactly what types of information are being transmitted.

GSM-R frame structure provides the basis for the various physical channels used within GSM-R, and accordingly it is at the heart of the overall system.

The basic GSM-R time frame lasts for approximately 4.615 ms (i.e. 120/26 ms) and it forms the basic unit for the definition of logical channels. Each basic frame is further divided into 8 time slots, as illustrated in FIG. 2. Each time slot has a duration of 0.577 ms (15/26 ms), which is shared by different users within the GSM-R system. The slots for transmission and reception for a given GSM-R terminal are offset 3 time slots so that the terminal does not have to transmit and receive at the same time.

The basic GSM-R frame defines all the timing of the GSM-R messaging and signaling.

In brief, GSM-R base station transmits two types of channel, namely the traffic channel and the control channel. Accordingly the channel structures are organized into two different types of frames, one for the traffic on traffic carrier frequency, the other for the control signaling on broadcast channel (BCCH) carrier frequency.

GSM-R frames are grouped together to form multi-frames. This way, the time schedule could be established for the network operation and network synchronization (refer to FIG. 3).

There are 2 types of GSM-R multi-frames, traffic multi-frame and control multi-frame.

Traffic multi-frame comprises 26 TDMA frames and last 120 ms. Out of 26 TDMA frames, 24 frames are used for traffic, numbered as 0 to 11 and 13 to 24. For the remaining two, one (Frame 12) is used to accommodate SACCH which supervises each call in progress, and the other (frame 25) is reserved.

The SACCH in frame 12 contains eight channels, one for each of the eight connections carried by the TCHs. The SACCH in position 25 is currently reserved and may carry eight additional SACCH channels when half rate traffic is implemented. A Fast Associated Control Channel (FACCH) works by stealing slots from a traffic channel to transmit power control and handover signaling messages. The channel stealing is done by setting one of the control bits in the time slot.

Control multi-frame comprises 51 bursts and occupies 235.4 ms. This control multi-frame always work on the BCCH carrier frequency in time slot 0, and may also occur within slots 2, 4 and 6 of the BCCH carrier frequency as well.

Control multi-frame is subdivided into logical channels which are time-scheduled. These logical channels and their functions are:
FCCH: Frequency correction burst
SCH: Synchronization burst
BCCH: Broadcast channel (BCH)
Paging and Access Grant Channel (PACCH)
Stand Alone Dedicated Control Channel (SDCCH)

GSM-R multi-frames are then constructed into super-frames taking 6.12 seconds. 2048 super-frames are grouped together to form 1 hyper-frame which repeats every 3 hours 28 minutes 53.76 seconds.

Within the GSM-R hyper-frame, there is a counter and every time slot has a unique sequential number which comprises the frame number and time slot number. This is used to for maintaining synchronization of the different scheduled operations within the GSM-R frame structure.

The different scheduled operation within the GSM-R frame structure comprise:
Frequency hopping: frequency hopping is a feature that is optional within the GSM-R system. It can help reduce interference and fading issues, but for it to work, the transmitter and receiver must be synchronized so they hop to the same frequencies at the same time.
Encryption: encryption process is synchronized over the GSM hyper-frame period where a counter is used and the encryption process will be repeated within each hyper-frame.

GSM-R frame structure is summarized in FIG. 3. By structuring the GSM-R signaling into frames, multi-frames, super-frames and hyper-frames, the timing and organization is set into a logically numeric order that enables both the GSM-R mobile and base station to communicate in a reliable and efficient manner. The GSM-R frame structure forms the basis form various GSM-R channels.

Various technologies can be used to provide ground to train communications. These include GSM, CDMA2000, 1XEVDO, WCDMA, HSPA, 802.16, 802.11b/g/a/n etc. However, as aforementioned, these systems are not designed for a high speed train which comes and goes. Although GSM-R may handle the Doppler caused by high speed train velocity, GSM-R has a very limited data capacity and couldn't provide high speed interne services for passengers on the train.

### 3. SUMMARY OF THE INVENTION

The invention discloses a system and apparatus for ground to high speed train communication as illustrated in FIG. 4, FIG. 5 and FIG. 6.

Various exemplary embodiments are summarized as in the following. Certain simplifications and omissions are made to highlight and to introduce some aspects of the exemplary embodiments which will not limit the scope of the invention. Detailed descriptions of a preferred exemplary embodiment are adequate to those having skills in the art to make and to use the inventive system concepts and methods.

The disclosed system comprising: 1) a GSM-R time frame aligned central scheduler, 2) a line-array of ground access points, 3) a cabin communication system, provides an “always on” virtual high speed data link between the ground central scheduler and the cabin radio resource control module mounted inside the high speed train.

The line-array of ground access points are connected to the central scheduler by a distributed transmission system, preferably a fiber backhaul.

The cabin communication system mounted on the train comprises external wireless system and internal distribution wireless system. The external wireless system will sequentially communicates with ground access points when train arrives in their coverage range; the internal wireless system will buffer the data received from external system and reschedule and re-distribute the data to passenger terminals to form a virtual non disconnection communication links. IEEE 802.11n a.k.a high speed WiFi can be modified and used as external wireless system.

The GSM-R frame aligned central scheduler determines which ground access point radio to turn on/off and which packets it will transmit or receive, basing on train arrivals, location information and GSM-R frame numbers and timers and radio link qualities.

GSM-R frame aligned central scheduler may instruct the ground access points, and the cabin communication system radio resource control module, and cabin external transceivers to change radio frequencies, channel bandwidth, power level, antenna gain etc. dynamically.

Basing on high speed train time of arrival, ground access point geo-location, and GSM-R frame timing, GSM-R frame aligned central scheduler may generate a layer 2 data frames and pre-assign layer 2 data frames to each ground access point, access point will transmit or receive those pre-assigned layer 2 frames, when the pre-assigned GSM frame timing arrives.

Basing on high speed train time of arrival, ground access point geo-location, and GSM-R frame timing, ground access point will alert the next ground access point to wake up and prepare for communication.

### 4. DESCRIPTION OF DRAWINGS

The present invention will be further understood from the following detailed description and reference drawings.

FIG. 1 ETCS train control system

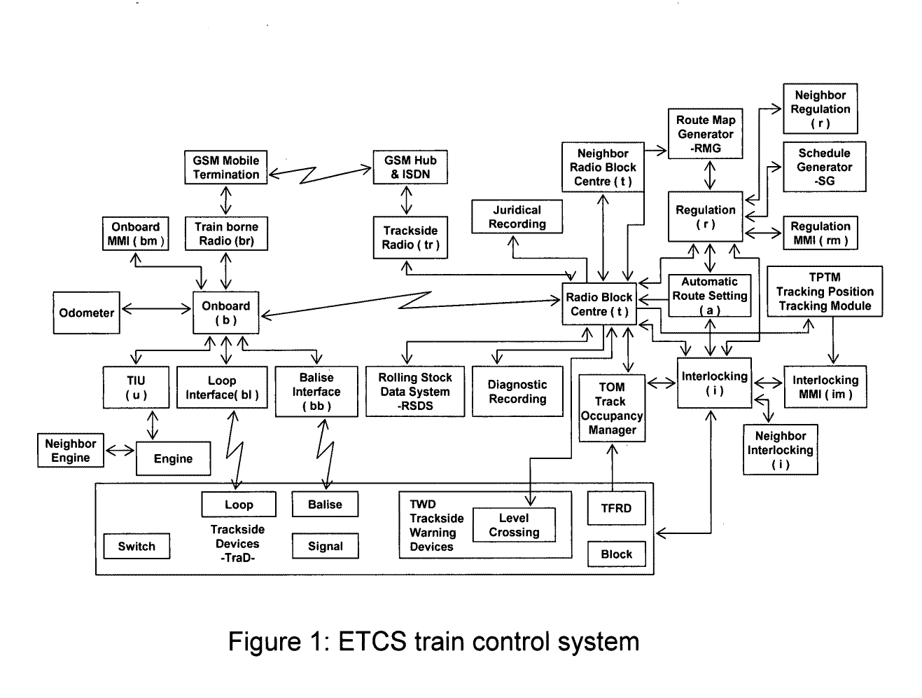

FIG. 2 Basic GSM-R frame structure

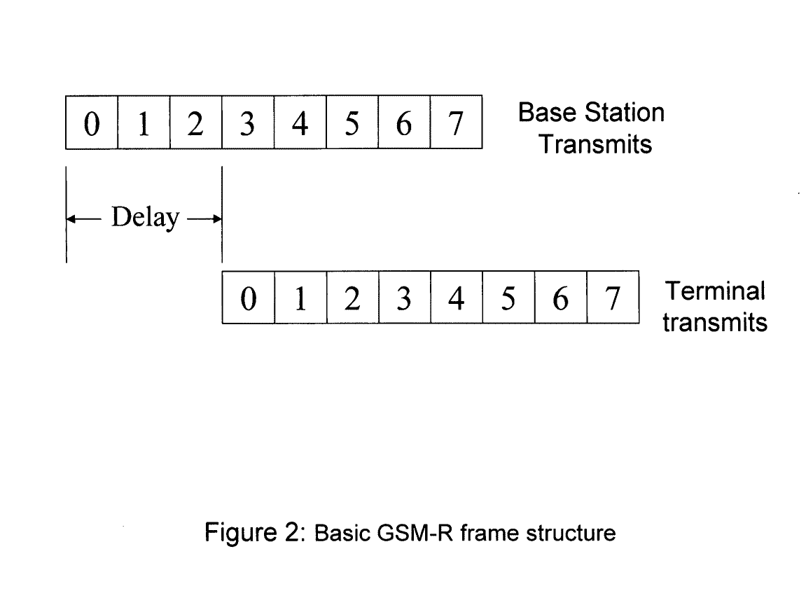

FIG. 3 GSM-R multi-frame, Super-frame and Hyper frame

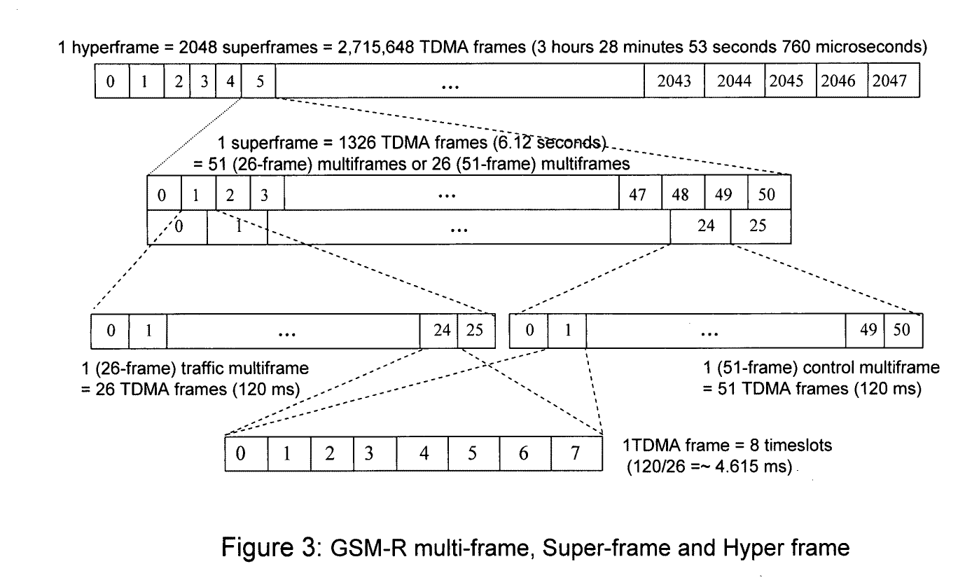

FIG. 4 GSM-R synchronized high speed train communication system

FIG. 5 Cabin communication system

FIG. 6 Big data packet is divided into multiple smaller packets which are pre-assigned to each access point for transmission or reception

### 5. DETAILED DESCRIPTION OF THE INVENTION

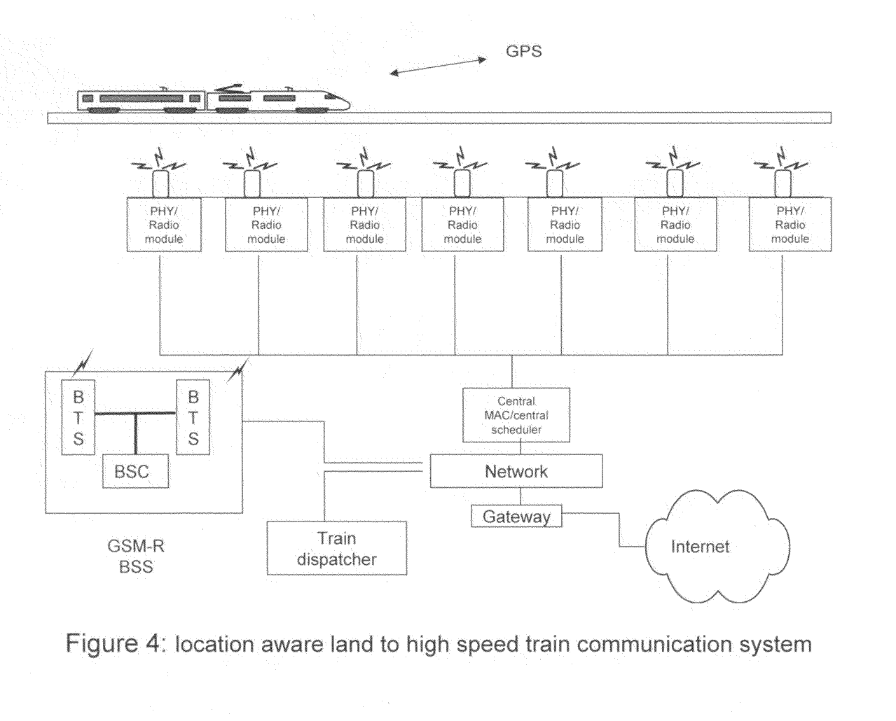

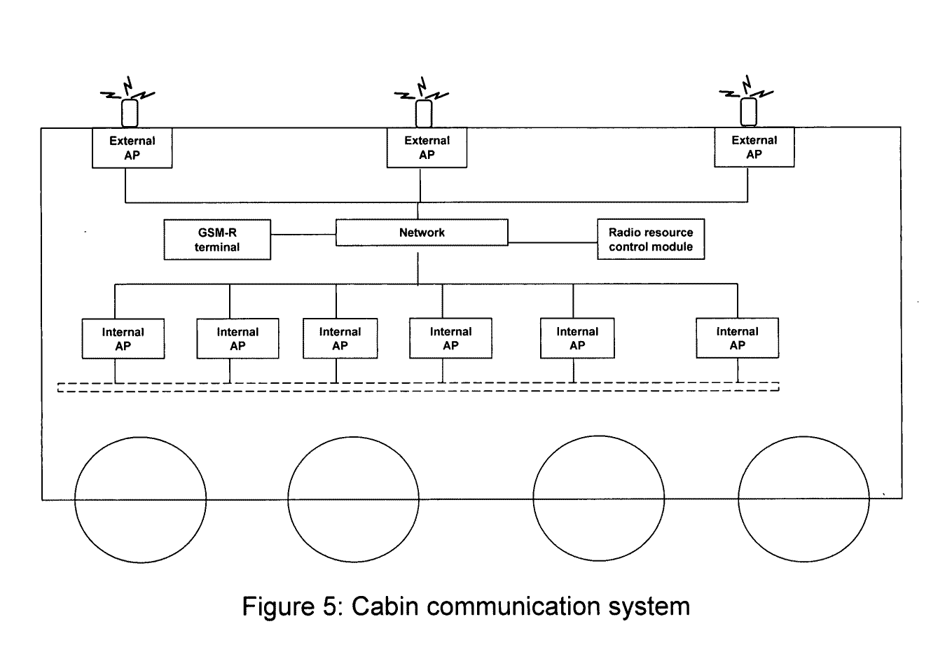

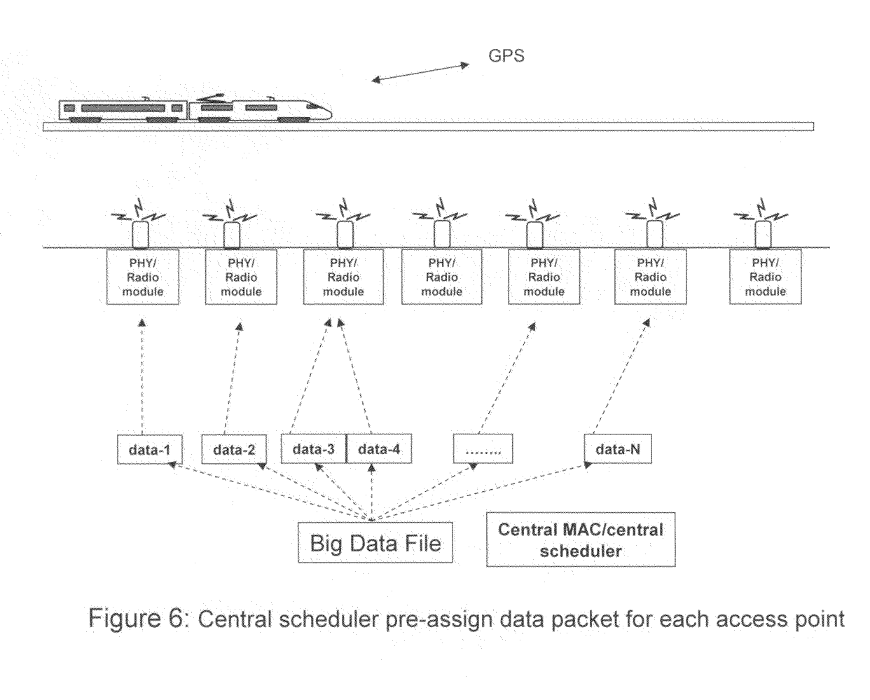

The invention proposes a cost effective wireless system and apparatus for ground to high speed train data communication, see FIG. 4, FIG. 5 and FIG. 6.

The proposed system, comprises 1) a GSM-R frame aligned central scheduler, 2) a line-array of ground access points, 3) a cabin communication system, provides an “always on” virtual high speed data link for passengers.

The line-array of ground access points are connected to the central scheduler by a data distribution system preferably a fiber backhaul link or access points themselves.

The cabin communication system mounted on the train comprises external wireless system and internal distribution wireless system. The external wireless system will sequentially communicates with ground access points when in their coverage range; the internal wireless system will buffer the data received from external system and reschedule and distribute to passenger terminals to form a virtual non disconnection communication links.

The central scheduler controls each ground access point for transmission and reception.

IEEE 802.11 air interface or other air interfaces can be applied for ground to train communications.

The central scheduler will be responsible for 1) to synchronize radio frame . timing with GSM-R frame timing, 2) to adapt MAC layer and allocate radio resource such as channel bandwidth, carrier frequency and transmission duration etc, 3) time tables for all the connected ground access points to transmit or receive or to be dormant, 4) to trigger each access point to turn on or turn off, 5) to inform the trains locations or distances from each access point so that it can prepare for transmission and reception 6) to fragment the big packet or data file into multiple pieces to distribute those data fragments to relevant access points 7) respective ground access point radio frame transmission start/stop control, 8) communication with train control system, 9) communication with internet, 10) communication with various service gateway.

Upon receive the instructions from the central scheduler, the ground access point shall perform 1) radio module on/off control, 2) start/stop radio frame transmission, 3) acknowledge the received radio frames, 4) pass on the received radio frames to the central scheduler, 5) self diagnostics and surrounding environment measurements, 6) report network management information etc.

The cabin communication system comprises 1) the radio resource control module, 2) external antennas, 3) transceiver module, 4) internal distributed antenna system, 5) internal distributed transceivers and 6) internal distribution transceiver system.

The radio resource control module connects to the external transceiver and internal distribution transceiver through the internal distribution transmission links.

The external antenna connects to the external transceiver directly.

The internal distribution antenna connects to the internal transceiver through feeder cable.

The radio resource control module is responsible for 1) MAC layer and radio resource control, 2) timing control to all the connected transceivers, 3) respective transceiver radio module on/off control, 4) respective transceiver radio frame transmission start/stop control and 5) synchronize its radio frame timing with GSM-R frame timing.

The passenger can start to browse internet from her/his device which communicates with internal transceivers.

Upon receive a data packet from internal transceiver, radio resource control module will process the data properly and control external transceiver to transmit to ground access points.

Under central scheduler control, respective ground access point will receive the 802.11 radio frames and pass on to the central scheduler. Center scheduler will process the frame, transmits to the internet gateway. Internet gateway will pass on to the internet.

Upon the response got received from the internet, the gateway will embed into Ethernet or other layer 2 format, transmit to central scheduler. Central scheduler will process the data frames; forward the data frames, through the virtual high speed data link ,towards respective access points which will “shot” the data frames to the train.

Upon receive a data packet from ground access point; train external transceiver array will pass on the received packet to the radio resource control module. Radio resource control module will process the data properly and retransmit it through the internal wireless transceivers to the passenger.

GSM-R frame aligned central scheduler may instruct the ground access points, and the cabin communication system radio resource control module, and cabin external transceivers to change radio frequencies, channel bandwidth, power level, antenna gain etc.

Basing on high speed train time of arrival, ground access point geo-location, and GSM-R frame timing, GSM-R frame aligned central scheduler may generate a layer 2 packet frames and pre-assign layer 2 frames to each ground access point, access point will transmit or receive those pre-assigned layer 2 frames according to the derived GSM frame timing.

Basing on high speed train time of arrival, ground access point geo-location, and GSM-R frame timing, ground access point will alert the next ground access point to wake up and prepare for communication and will inform the lost data packets for re-transmission.

The ground access point may have a video camera equipped as a train arrival sensor. When train arrives, video camera will trigger the access point to wake up.

We claim:

1. A ground-to-train communication system comprising: a central scheduler time synchronized with GSM-R frame timing; a line-array of ground access points; a cabin communication system has both external transceivers and internal transceiver; The line-array of ground access points communicates to the train cabin communication system and the ground access points are triggered by a presence of a train; The central scheduler communicates to a ground access point through a distribution backhaul or other ground access points.

2. A central scheduler time synchronized with GSM-R frame timing as claimed in claim 1 comprises a decision module which instructs the relevant ground access points to transmit or to receive the pre-assigned data packets.

3. A central scheduler time synchronized with GSM-R frame timing as claimed in claim 1 instructs ground access point when to turn on or turn off basing on train time of arrival, train speed, train geo-location, ground access point geo-location, out standing data remaining and services type etc.

4. A central scheduler time synchronized with GSM-R frame timing as claimed in claim 1 employs train time tables, train speed and geo-location information to calculate a decision for a ground access point to reconfigure its transceiver frequency and bandwidth, to transmit or to receive with pre-assigned data packets for each access point.

5. A central scheduler time synchronized with GSM-R frame timing, as claimed in claim 1, adapts MAC layer and radio resource control to the ground access points according to service type and may fragment a data file or packet into multiple pieces and pre-assign one piece or multiple pieces to an access point for transmission or reception.

6. The line-array of ground access points, as claimed in claim 1 comprising: antennas; transceiver modules and radio resource control modules; Ground access points will either follow the instructions from central scheduler or to wake up to transmit or to receive by calculating a train arrival.

7. A ground access point as claimed in claim 6 may calculate a train arrival by train time table, train speed, geolocation, its adjacent access points transmission activities etc.

8. A ground access point, as claimed in claim 6 will do self diagnostics regularly and report network management information such as link failure, interference scenario, and adjacent access points status etc.

9. A ground access point, as claimed in claim 6, will do statistics on each train of arrival. The statistics includes: Train external transceivers configurations; data traffic loads; SNR scenario; train speed; train direction; communication duration with train etc.

10. A ground access point, as claimed in claim 6 will return to sleep mode according to train time table and its geolocation.

11. A ground access point as claimed in claim 6 maybe triggered by a video camera to wake up or to sleep.

12. A cabin communication system, as claimed in claim 1 comprising: a radio resource control module; external antennas; an array of external transceivers mounted on the train and an internal distribution system.

13. A radio resource control module, as claimed in claim 12, contains a decision module which controls internal and external transceivers and turn them on/off.

14. A radio resource control module as claimed in claim 12 synchronizes its clock with GSM-R frame timing.

15. A radio resource control module, as claimed in claim 12 allocates radio resources to external and internal transceivers according to power level, interferences level, geo-location, and train speed and spectrum availability in different regions.

16. An array of external transceivers mounted on the train as claimed in claim 12 may use the learned knowledge in the past and geo-location information to dynamically configure its radio parameters such as frequency, bandwidth, power level etc.

17. The learned knowledge as claimed in claim 16 comprising: The accumulated mileage from origin; the calculated access points IDs and their personality; the statistical interference in a region; statistical SNR; statistical bit-error-rate or frame-error-rate etc.
